(19) United States
(12) Patent Application Publication
(10) Pub. No.: US 2008/0016925 A1
(43) Pub. Date: Jan. 24, 2008

(54) Strut safety lock device

(76) Inventor: Richard Hawkinberry, Gilmer, TX (US)

Correspondence Address: RONALD B. SEFRNA, P.O. BOX 567, TYLER, TX, 75710, US

(21) Appl. No.: 11/880,685

(22) Filed: Jul. 24, 2007

Related U.S. Application Data
(60) Provisional application No. 60/832,701, filed on Jul. 24, 2006.

(51) Int. Cl. G05G 5/00

(52) U.S. Cl. 70/181

(57) ABSTRACT

A device for locking a telescoping strut, having a cylinder and a piston extensible from and retractable into the cylinder, in an extended position includes a generally rectangular body with a stepped slot extending into the body from one end, and a threaded bolt that extends through an aperture on one side of the slot at the slot opening, and engages threads formed in a coaxially aligned aperture in the opposite side of the slot. The body of the device is inserted over the piston arm of a strut, and the bolt is inserted and tightened to deform the body so that it grips the piston arm and prevents the piston from moving into the strut cylinder, preventing the strut from collapsing.

### RELATED APPLICATION DATA

This application claims the benefit of U.S. Provisional Patent Application Ser. No. 60/832,701, filed Jul. 24, 2006.

### FIELD OF THE INVENTION

The present invention generally relates to locking or latching devices, and in its preferred embodiments more specifically relates to a device for locking telescoping struts, such as but not limited those used to support automotive hoods.

### BACKGROUND

It has become common practice in, especially, the automotive field, for engine compartment hoods and covers, trunk lids, tailgates, and the like to be supported by gas filled or liquid filled struts. Such struts comprise an outer cylinder and a piston that moves in telescoping relation with the cylinder, with one end of the piston within the cylinder and the other end extending from the cylinder through a seal assembly. The cylinder is filled with a gas or liquid to provide a damping and counterbalancing effect against movement of the piston. Cylinders and pistons of several different diameters are commonly used in the automotive industry.

One of the most important functions of such struts is maintaining the hoods, etc. (generally referred to for convenience as “hood”) in a fully open position. With time and use it is not uncommon for the struts to wear and at least partially lose function, so that they are no longer capable of supporting the hood in an open position. Depending upon the degree of wear or damage, some malfunctioning struts may allow a hood to drop slowly, and some may have become incapable of supporting the hood at all. Struts may also fail suddenly, allowing a hood to drop rapidly from an open to a closed position.

Loss of strut function or strut failure poses safety risks of injury to mechanics and others working under the hood, as well as risk of damage to the hood itself. In an effort to reduce these risks mechanics often prop a hood in an open position, using an elongate rod. Although propping a hood open does provide some degree of security, the practice has a number of drawbacks and disadvantages, and is neither fully effective nor safe.

There is a great deal of variation in vehicle designs and dimensions, and a prop of an appropriate length to support the hood of one vehicle is likely to be of an inappropriate length for another vehicle. Accordingly, a mechanic who uses props in this manner must either have a variety of props available, or may attempt to use a prop of an inappropriate length, further compromising safety. Even if a prop seems to be of an appropriate length, a prop may slip or may be dislodged by a person working under the hood, allowing the hood to drop rapidly, injuring the worker and/or damaging the vehicle. The use of a prop or props to support a hood also interferes with access to the mechanical components under the hood, where work space and access is often limited under the best of conditions.

There remains an unfilled need for an effective means of assuring that a hood will remain in an open position regardless of the condition of the struts, without restricting access to the space under the hood, and without imposing a risk of injury or damage.

### SUMMARY OF THE INVENTION

The device of the invention provides a locking means for locking the position of the piston of a strut relative to the cylinder so as to prevent travel of the piston into the cylinder. The device comprises a generally rectangular body with a stepped slot extending into the body from one end. A threaded bolt or other tightening means is extendable through an aperture on one side of the slot at the slot opening, and engages threads formed in a coaxially aligned aperture in the opposite side of the slot. The body of the device is inserted over the piston arm of a strut, and the bolt is inserted and tightened to deform the body so that it grips the piston arm and prevents the piston from moving into the strut cylinder, thereby preventing the strut from collapsing.

The structure and features of the device of the invention will be described in detail below, with reference to the accompanying drawing figures.

### BRIEF DESCRIPTION OF THE DRAWINGS

FIG. 1 is a top plan view of the preferred embodiment of the device of the invention, with the bolt in place.

FIG. 2 is a partially sectioned top plan view of the preferred embodiment of the device of the invention, without the bolt

FIG. 3 is a right side elevation view of the preferred embodiment of the device of the invention, without the bolt.

FIG. 4 is an end view of the preferred embodiment of the device of the invention, along line 4-4 of FIG. 1, without the bolt.

FIG. 5 is a side view of the preferred embodiment of the device of the invention, in place on a strut.

FIG. 6 is a top plan view of an alternative embodiment of the device of the invention.

FIG. 7 is a left side elevation view of the alternative embodiment shown in FIG. 6.

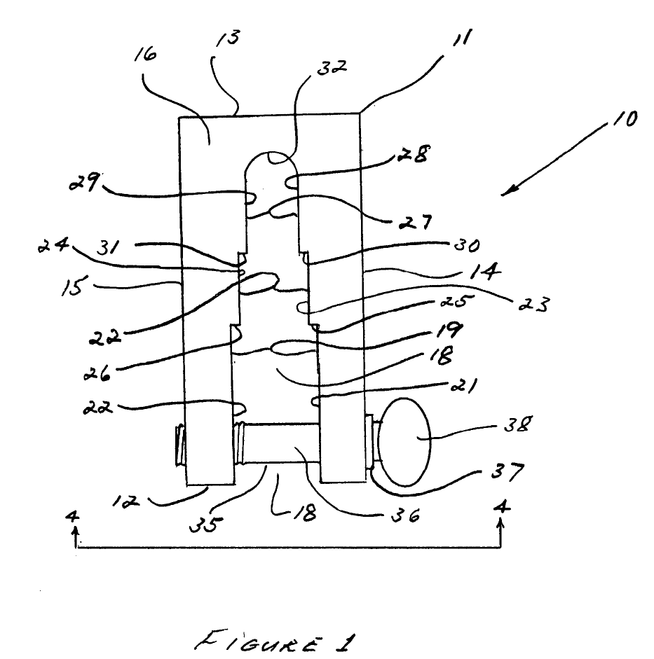

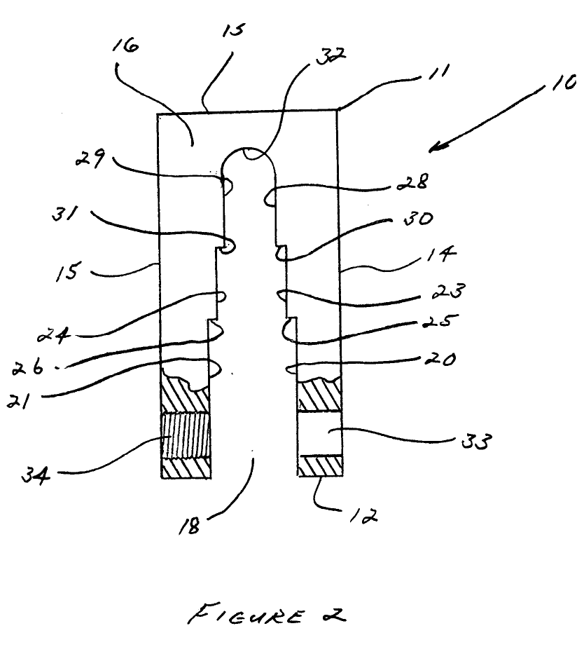

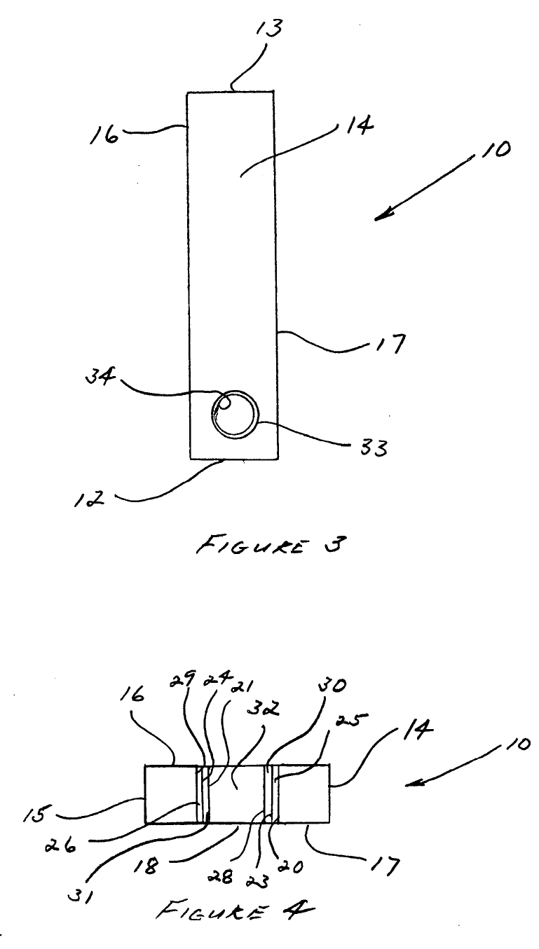

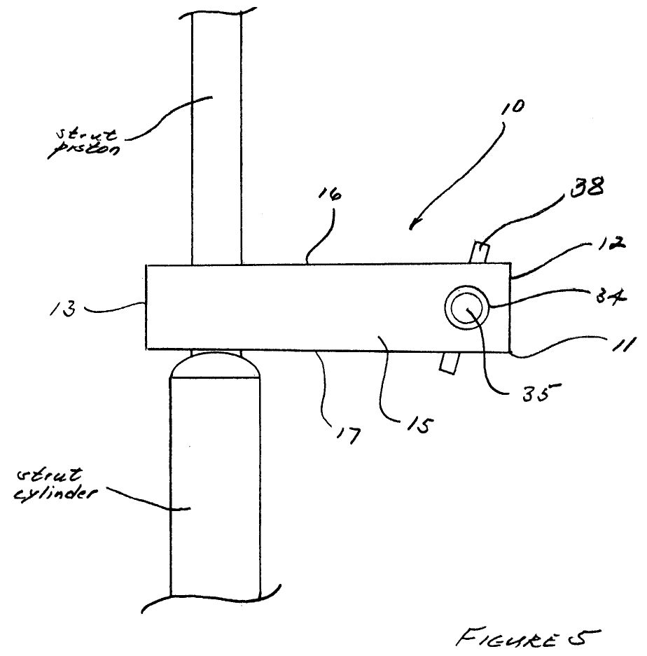

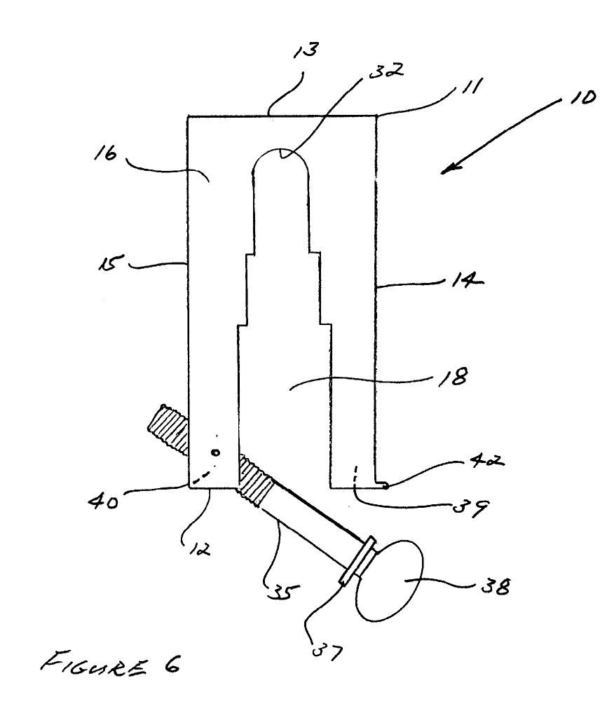

### DESCRIPTION OF THE INVENTION

Referring now to the drawing figures, the device of the invention, generally designated by reference number 10, is preferably formed as a generally rectangular planar body 11, with a first end 12, a second end 13, a first side edge 14, a second side edge 15, a first face 16, and a second opposed face 17.

A stepped slot 18 is formed in body 11, extending from first end 12 the majority of the distance through body 11 toward second end 13, with the longitudinal as of slot 18 coaxially aligned with the longitudinal axis of body 11, so that slot 18 is disposed equidistant between side edges 13 and 14. From the first end of the body slot 18 extends toward second end 13 at a first width 19 between first step edges 20 and 21, and then narrows to second width 22, between second step edges 23 and 24, forming first step ledges 25 and 26. Slot 18 continues from first step ledges 25 and 26 a farther distance toward the second end of the body at second width 22, and then again narrows to a third width 27 between third step edges 28 and 29, forming second step ledges 30 and 31. Slot 18 continues from second step ledges 30 and 31 to its inner end 32, which is preferably formed as a semi-circular curve between third step edges 28 and 29.

First width 19, second width 22, and third width 27 correspond to the diameters of the pistons of three selected strut sizes. In the preferred embodiment first width 19 is 12 mm, second width 22 is 10 mm, and third width 27 is 8 mm, but it is to be understood that the scope of the invention is not limited to any particular slot dimensions, and other dimensions may readily be used to fit the piston diameters of any selected strut sizes.

The portion of body 11 between first edge 14 and first step edge 20 of slot 18 is penetrated by a first aperture 33, disposed adjacent to first end 12 of body 11, with the axis of first aperture 33 generally equidistant between first and second faces 16 and 17 of body 11 and perpendicular to the longitudinal axis of the body. The portion of body 11 between second edge 15 and first step edge 21 of slot 18 is penetrated by a second, threaded aperture 34, disposed in coaxial alignment with first aperture 33. Apertures 33 and 34 are circular in cross-sectional configuration, and the diameter of first aperture 33 is slightly larger than the diameter of second aperture 34. A bolt 35 is extendable through first aperture 33 and into threaded engagement with second aperture 34. Bolt 35 includes a threaded shaft 36, is preferably fitted with a washer 37 to bear against edge 14 of body 11, and also includes a head 38 for rotating the bolt. In a variation, bolt 35 may be formed with a flange adjacent to the bolt head instead of washer 37. Head 38 is preferably formed as a flat plate or wing to facilitate tightening bolt 35 by hand, but it is to be understood that the scope of the invention is not limited to any particular bolt configuration.

Body 11 is formed of a generally rigid shape retentive material. The material of construction will allow a slight deformation of body 11 so that slot 18 will narrow or constrict when bolt 35 is extended through apertures 33 and 34 and tightened, but will return to its original dimension when bolt 35 is again loosened. The material of construction will withstand repeated cycles of tightening and loosening without failure. A preferred material of construction is aluminum or an aluminum alloy, but the scope of the invention is not limited to any particular material, and any material of construction, including but not limited to other metals or a plastic material, with appropriate properties may be used.

The device of the invention is used by first removing bolt 35, or withdrawing it sufficiently to allow the piston of a strut to pass into slot 18. The strut to be locked is extended, and the device is placed around the strut piston immediately adjacent to the strut cylinder with the strut piston received in slot 18 at the first end 12 of body 11. Body 11 is moved across the strut piston until further movement is prevented when the piston reaches inner end 32 of slot 18 or abuts against sets of ledges in slot 18, as the case may be. Bolt 35 is then extended through aperture 33, threaded into aperture 34, and tightened to constrict slot 18 around the strut piston and lock the strut piston against retraction into the strut cylinder. With retraction of the strut piston prevented, the hood or other component supported by the strut is secured in an open position and prevented from closing until the device is loosened and removed to free the strut piston. In most instances locking a single strut is sufficient to prevent lowering of the hood, etc. even if two supporting struts are present. However, all supporting struts may be locked if desired.

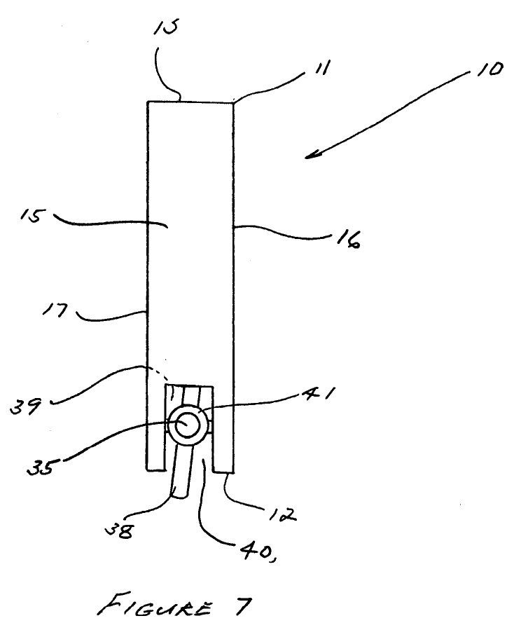

Although the positive retention of bolt 35 achieved by extending it through apertures disposed inward of the first end of the body is preferred for security and safety, variations in construction of the device are within the scope of the invention. In an alternative embodiment, illustrated in FIGS. 6 and 7, bolt 35 is pivotally connected to body 11. In this embodiment apertures 33 and 34 are replaced by open ended slots 39 and 40 extending into body 11 from first end 12 on either side of slot 18. A threaded nut 41 is pivotally connected in slot 39 and bolt 35 is threaded into nut 41. In this embodiment bolt 35 may be loosened sufficiently to allow the bolt head and washer, or flange, to rotate with nut 41 around its pivotal connection to clear slot 18 for installation of the device, and then rotated back into slot 40 and tightened against edge 14 to lock the strut. In this embodiment it is preferred that a ledge 42 be formed at the intersection of first end 12 and edge 14 of body 11 to retain bolt head 38 when the bolt is tightened, and prevent the bolt from inadvertently disengaging and releasing the strut piston. In a variation, nut 41 may be omitted from slot 39 and a conventional bolt inserted into slots 39 and 40 after the body of the device is placed on a strut, and a conventional nut threaded on the bolt and tightened to lock the device on the strut. In this variation a ledge 42 is preferably disposed relative to slot 39 in the same manner as described in reference to slot 40. In a further variation of the preferred embodiment, aperture 34 may be enlarged to match aperture 33 and formed without threads, and a conventional bolt extended through both apertures and tightened with a conventional nut.

The foregoing description of the device of the invention is intended to be illustrative and not limiting. The device is subject to further alternative embodiments and variations, all within the scope of the invention in accordance with the following claims.

1. A removable locking device for a strut assembly, the strut assembly having a cylinder and a piston extendable from and retractable into the cylinder, comprising,
a generally rectangular planar body with a first end, a second end, a first side edge, a second side edge, a first face, and a second face, said body having a longitudinal axis extending through said first and second ends and equidistant between said first and second side edges and between said first and second faces, said body having a stepped slot extending into said body from said first end toward said second end and between said first and second faces, said slot having an axis coaxially aligned with said longitudinal axis of said body, and said slot having a first inner edge and a second inner edge, said body having a first aperture extending between said first side edge of said body and said first inner edge of said slot generally perpendicular to said longitudinal axis of said body, and a second, threaded aperture extending between said second side edge of said body and said second inner edge of said slot in coaxial alignment with said first aperture, said body to be disposed on the extended piston of a strut adjacent to the cylinder of the strut with the piston of the strut received in said slot; and
an elongate bolt having a head at one end thereof, said bolt being threaded at the opposite end thereof, said bolt to be extended through said first aperture and threadably engaged in said second aperture with said head of said bolt received against said first side edge of said body, such that rotation of said bolt forces said inner edges of said slot against the piston of the strut, locking said body around the piston and preventing the piston from recessing into the cylinder of the strut.
